(19) United States
(12) Patent Application Publication
(10) Pub. No.: US 2012/0204676 A1
(43) Pub. Date: Aug. 16, 2012

(54) Two Shaft Transmission Having Chain Driven Reverse

(76) Inventors: Richard L. Walters, Plano, IL (US); Richard L. Walters, II, Plano, IL (US)

(21) Appl. No.: 13/024,851

(22) Filed: Feb. 10, 2011

(51) Int. Cl. F16H 47/06; F16H 3/08

(52) U.S. Cl. 74/732.1; 74/325

(57) ABSTRACT

A transmission for a vehicle has an output shaft, a main shaft and a countershaft. The main shaft is arranged to receive rotary power and the countershaft is arranged in parallel to the main shaft. A plurality of meshed gear pairs are formed main gears and counter gears on the two shafts. A plurality of clutch devices are arranged to select a gear pair that will transmit torque to the output shaft. A reverse drive is created by a main reverse gear on the main shaft, a counter reverse gear on the counter shaft and a chain wrapping the main reverse gear and the counter reverse gear. A reverse clutch device is arranged to selectively fix one of the main and counter reverse gears to its respective main or counter shaft for rotation.

### FIELD OF THE INVENTION

This invention relates in general to transmissions and in particular to transmissions for small vehicles.

### BACKGROUND OF THE INVENTION

The invention relates particularly to transmissions for smaller, fuel efficient vehicles, such as utility terrain vehicles (UTV), on highway micro-cars, and mini-cars and trucks. It is important in these vehicles that smaller vehicles minimize weight and bulk for operating components such as transmissions.

U.S. Pat. No. 6,725,962 discloses a transmission for an all terrain vehicle (ATV). This transmission utilizes three shafts to transmit power from a continuously variable transmission (CVT) to vehicle wheels.

The inventors have recognized that it would be advantageous to provide a transmission for a vehicle having a compact design and that can accomplish gear selection with two shafts, including a reverse gear. The inventors have recognized that it would be advantageous to provide an automatic transmission for a small vehicle that is compact, weight efficient and reliable.

### SUMMARY OF THE INVENTION

The invention provides a transmission for a vehicle that includes a geartrain that includes a main shaft for receiving rotary power from an engine output and a countershaft arranged in parallel to the main shaft. The main shaft carries a plurality of main forward gears. The countershaft carries a plurality of counter forward gears. A plurality of forward gear pairs are formed by each of the main forward gears being arranged to form one gear pair with one of the counter forward gears, the gear pairs being in constant mesh. A reverse main gear drives a reverse counter gear via a chain or belt forming a reverse gear pair. An output pulley is rotatably mounted on the main shaft. A plurality of clutch devices are arranged to select a gear pair from the plurality of gear pairs that will transmit torque to the output pulley.

The invention provides an automatic transmission for a vehicle that includes a torque converter. The torque converter includes a torque converter housing, a torque converter input pulley arranged to receive rotary power from the engine output and a torque converter output shaft for transmitting rotary power to the geartrain. The torque converter includes fluid coupling elements arranged within the housing to transmit torque between the torque converter input pulley and the torque converter output shaft.

According to one preferred embodiment, at least one clutch device comprises a clutch plate or drum fixed on the main shaft, and at least one clutch friction disk arranged between the clutch plate and one gear of the select gear pairs. The friction disk is selectively engageable to the clutch plate and to the one gear to transmit torque between the clutch plate and the one gear.

According to another preferred embodiment, at least one clutch device comprises a clutch plate fixed on the countershaft, and at least one clutch friction disk arranged between the clutch plate and one gear of the select gear pair. The friction disk is selectively engageable to the clutch plate and to the one gear to transmit torque between the clutch plate and the one gear.

The geartrain can be a four speed geartrain, wherein fourth gear can be a direct drive located furthest from the torque converter. A first gear pair can be located next to the fourth gear between the fourth gear and the torque converter. A second gear pair can be located next to the first gear pair and between the first gear pair and the torque converter. A third gear pair can be located next to the second gear pair and between the second gear pair and the torque converter. A reverse gear pair can be located next to the third gear pair and between the third gear pair and the torque converter.

According to the preferred embodiment, the torque converter input pulley is located between the torque converter housing and the reverse gear pair.

According to a preferred embodiment at least some of the clutch devices each comprise one clutch plate fixed to the main shaft or the counter shaft with engageable opposite sides. The clutch plate can be arranged between alternately selectable gear pairs, and at least one friction disk is arranged between each of the selectable gear pairs and one engageable opposite side of the clutch plate. Each friction disk is selectively actuatable to engage one gear of the selectable gear pair to the clutch plate to transmit torque between the clutch plate and the selectable gear pair to transmit torque to the output pulley.

The transmission assembly of the present invention provides a compact, relatively simple automatic transmission that is particularly adapted for use on small vehicles.

The transmission assembly of the present invention provides a two shaft transmission that provides a reverse gear and multiple forward gears.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a schematic plan view of a drivetrain of vehicle incorporating the transmission of the present invention;

FIG. 2 is a schematic legend diagram for understanding the following schematic diagrams;

FIG. 3 is a schematic plan view of the transmission shown in FIG. 1 with the transmission shown in a first gear mode of operation;

FIG. 4 is a schematic plan view of the transmission of FIG. 3 with the transmission shown in a second gear mode of operation;

FIG. 5 is a schematic plan view of the transmission of FIG. 3 with the transmission shown in a third gear mode of operation;

FIG. 6 is a schematic plan view of the transmission of FIG. 3 with the transmission shown in a fourth gear mode of operation;

FIG. 7 is a schematic plan view of the transmission of FIG. 3 with the transmission shown in a reverse gear mode of operation; and

FIG. 8 is a schematic plan view of the transmission of FIG. 3 showing a control scheme.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

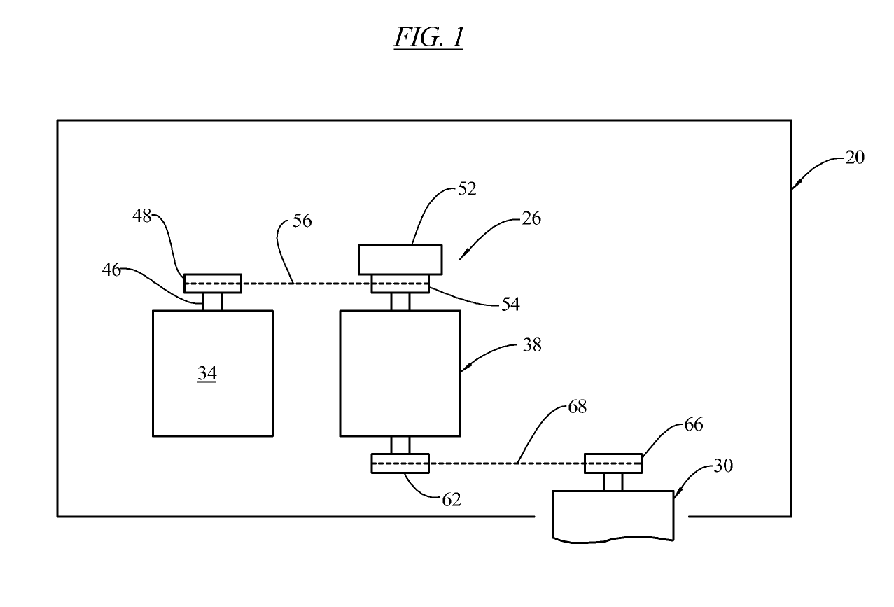

FIG. 1 illustrates a vehicle 20 having a drivetrain 26. The drive train 26 includes an engine 34, a transmission assembly 38 and a rear wheel 30. The engine 34 transmits rotary power via its crankshaft to an engine output shaft 46. The engine output shaft 46 is connected to an engine drive sprocket 48.

The transmission assembly 38 includes a torque converter 52 that has a torque converter drive sprocket 54.

A primary drive chain 56 is wrapped around the engine drive sprocket 48 and the torque converter drive sprocket 54. The transmission assembly 38 includes a transmission output pulley 62. A rear drive pulley 66 is operatively connected to the rear wheel 30 to rotate the rear wheel 30. A secondary drive chain 68 is wrapped around the output pulley 62 and the rear drive pulley 66.

The terms “sprocket” and “pulley” denote elements having outside features that are engageable by either a chain or a belt, to be rotated thereby. A sprocket and a pulley can function in like fashion, and accordingly the terms are used interchangeably herein.

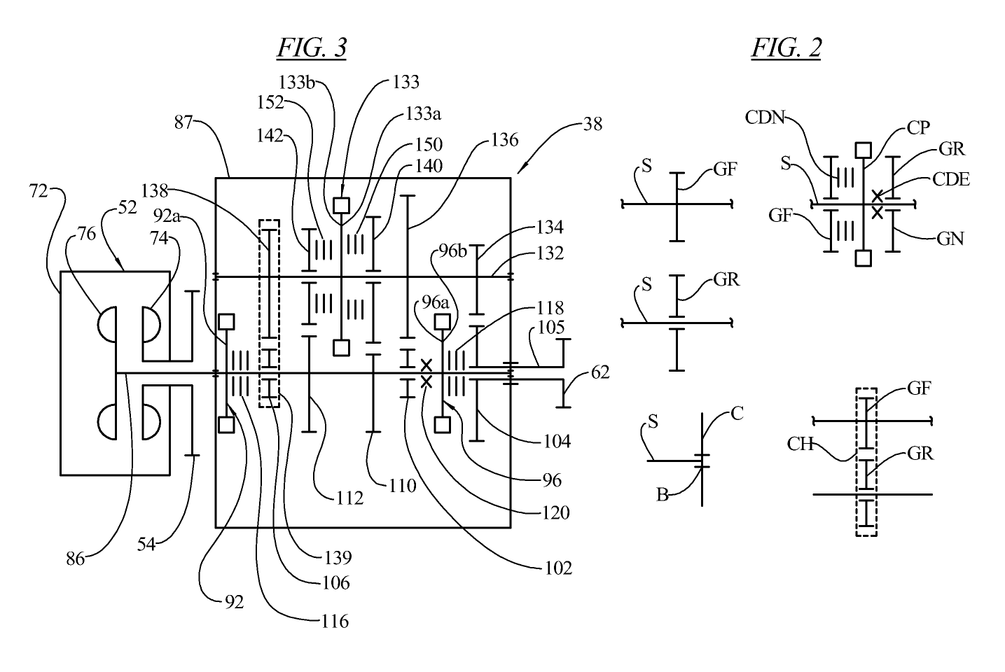

FIG. 2 illustrates a legend for the symbols used in FIGS. 3-8. The symbols are defined below.

GF=gear fixed to a shaft to rotate therewith

S=shaft

CDN=disengaged clutch friction disc

CP=clutch plate fixed to a shaft

CDE=clutch friction disc engaged to a clutch plate and a gear

GR=gear rotatable on a shaft

CH=chain or belt

B=bearing

C=casing or housing

FIG. 3 illustrates the transmission assembly 38 in first gear. The torque converter 52 includes a torque converter housing 72. Within the housing 72 are a driving rotary element 74 and a driven rotary element 76. The torque converter is shown in a simplistic way. For example, a stator can also be included within the housing between the driving rotary element 74 and the driven rotary element 76. Torque converters are well known and are described for example in U.S. Pat. Nos.: 4,070,925; 5,862,717; 2,897,690; 2,449, 608; 6,655,226; 6,390,262; and 6,805,026, all herein incorporated by reference. The torque converter housing 72, the driving rotary element 74, and the input pulley 54 are all fixed to rotate together. The driven rotary element 76 is fixed to a main shaft 86 of the transmission assembly 38. The torque converter housing 72 is journaled on the main shaft 86 or on a suitable extension thereof, by bearings and oil seals (not shown).

The main shaft 86 penetrates into a transmission casing 87 of the transmission assembly 38. The main shaft 86 receives rotary power from the torque converter 52 via a fluid coupling between the driving rotary element 74 and the driven rotary element 76, by rotation of the torque converter components 54, 72, 74. The main shaft 86 transmits rotary power to clutch plates 92, 96 that are fixed on the main shaft 86 to rotate therewith. The clutch plates 92, 96 can be keyed or splined to the shaft 86 or otherwise fixedly fastened to the shaft 86. The clutch plates include clutch engaging faces 92a, 96a, and 96b.

Preferably, the clutch assemblies are multiple disk wet clutches. The clutch plates are shown schematically as flat plates but are preferably of a drum configuration having a plurality of friction plates that are interleaved with friction disks of the clutch friction disk assembly such as shown and described in U.S. Pat. Nos. 4,623,055; 5,103,953; 4,131,185 or 3,266,608, all incorporated by reference.

A first main drive gear 102, a fourth main drive gear 104 and a reverse main drive gear 106 are mounted axially on the main shaft 86 but are free to rotate on the main shaft, i.e., are relatively rotatable with respect to the main shaft 86. The fourth main drive gear 104 is fixed to an output shaft 105 that mounts the output pulley 62.

A second main drive gear 110 and a third main drive gear 112 are fixedly mounted to the main shaft 86, i. e., there is no relative rotation between the gears 110, 112 and the main shaft 86. The gears 110, 112 can be keyed or splined to the main shaft 86 or otherwise fixedly fastened to the main shaft 86.

Clutch friction disks 116 are mounted on the main shaft 86 between the reverse drive gear 106 and the clutch plate 92. Clutch friction disks 118 are mounted on the main shaft 86 between the clutch plate 96 and the fourth drive gear 104. Clutch friction disks 120 are mounted on the main shaft 86 between the clutch plate 96 and the first drive gear 102. According to one embodiment, the clutch friction disks 116, 118, 120 are free to rotate on the main shaft 86, i.e., are relatively rotatable with respect to the main shaft 86.

A countershaft 132 is mounted within the transmission casing 87, parallel to the main shaft 86. The counter shaft 132 transmits rotary power to clutch plate 133 that is fixed on the counter shaft 132 to rotate therewith. The clutch plate 133 can be keyed or splined to the shaft 132 or otherwise fixedly fastened to the shaft 132. The clutch plate 133 includes clutch engaging faces 133a, 133b.

A drive counter gear 134, a first counter gear 136, and a reverse counter gear 138 are fixedly mounted to the counter shaft 132, i. e., there is no relative rotation between the gears 134, 136, 138 and the countershaft 132. The gears 134, 136, 138 can be keyed or splined to the countershaft 132 or otherwise fixedly fastened to the countershaft 132. The drive counter gear 134 is en mesh with the fourth main drive gear 104. The first counter gear 136 is en mesh with the first main drive gear 102. The reverse counter gear 138 is chain driven by the reverse main drive gear 106, via a chain 139; the gears 106, 138 are not en mesh, i.e. the gears 106, 138 rotate in the same direction.

A second counter gear 140 and a third counter gear 142 are mounted axially on the counter shaft 132 but are free to rotate on the counter shaft, i.e., are relatively rotatable with respect to the counter shaft 132. The second counter gear 140 is en mesh with the second main drive gear 110. The third counter gear 142 is en mesh with the third main drive gear 112.

Clutch friction disks 150 are mounted on the counter shaft 132 between the second counter gear 140 and the clutch plate face 133a. Clutch friction disks 152 are mounted on the counter shaft 132 between the third counter gear 142 and the clutch plate face 133b. According to one embodiment, the clutch friction disks 150, 152 are free to rotate on the counter shaft 132, i.e., are relatively rotatable with respect to the counter shaft 132.

The gears 102, 104, 106, 110, 112, 134, 136, 1138, 140, 142 all have outer circumferential teeth. The gear pair 102, 136 forms first gear; the gear pair 110, 140 forms second gear; the gear pair 112, 142 forms third gear and the fourth main drive gear 104 in effect forms fourth gear, i.e. a direct drive from the main shaft 86.

FIG. 3 illustrates the operation of the transmission in first gear mode. The torque converter 52 is turned via the input pulley 54. A fluid coupling within the torque converter turns the main shaft 86. The main shaft 86 turns the clutch plate 96 which turns first main drive gear 102 via the clutch friction disks 120 which are selected by a controller to be engaged to the clutch plate 96, particularly the face 96a. First main drive gear 102 turns the corresponding first counter gear 136, which turns the countershaft 132, which turns the counter drive gear 134, which turns the fourth main drive gear 104 that is fixed to the output shaft 105 and the pulley 62. The output pulley 62 is turned, which turns the rear wheel 30 via the drive sprocket 66 and the secondary chain 68.

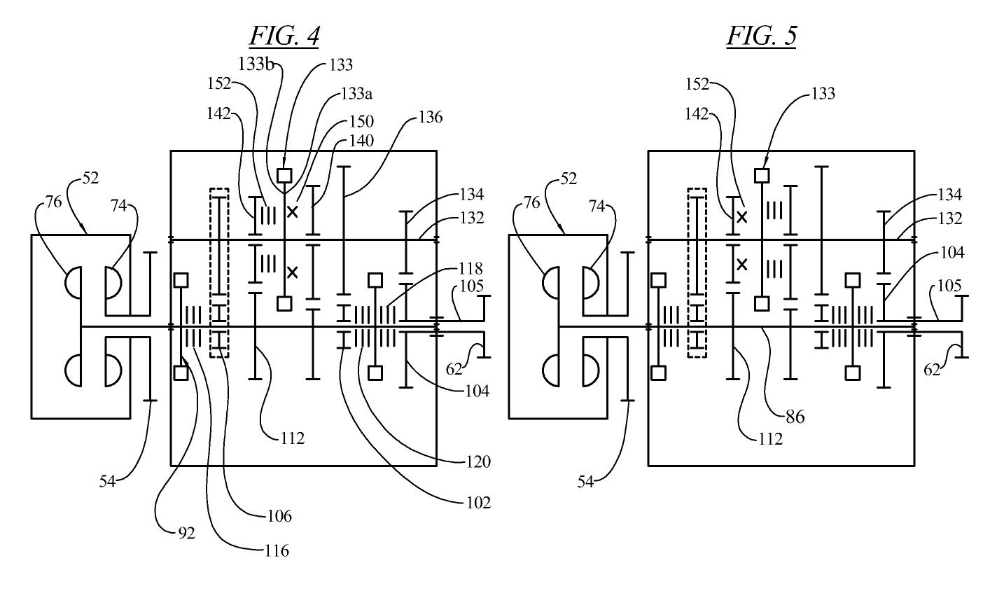

FIG. 4 illustrates the operation of the transmission in second gear mode. The torque converter 52 is turned via the input pulley 54. A fluid coupling within the torque converter turns the main shaft 86. The main shaft 86 turns the second main drive gear 110, which turns the second counter gear 140. The clutch control has engaged the clutch discs 150 to cause the second counter gear 140 to turn the clutch plate 133 at the same speed as the second counter gear 140. The clutch plate 133 turns the counter shaft 132 which turns the counter drive gear 134 which turns the fourth main drive gear 104 that is fixed to the output pulley 62. The output pulley 62 is turned, which turns the rear wheel 30 via the drive sprocket 66 and the secondary chain 68.

FIG. 5 illustrates the operation of the transmission in third gear mode. The torque converter 52 is turned via the input pulley 54. A fluid coupling within the torque converter turns the main shaft 86. The main shaft 86 turns the third main drive gear 112, which turns the third counter gear 142. The clutch control has engaged the clutch discs 152 to cause the third counter gear 142 to turn the clutch plate 133 at the same speed as the third counter gear 142. The clutch plate 133 turns the counter shaft 132 which turns the counter drive gear 134 which turns the fourth main drive gear 104 that is fixed to the output pulley 62. The output pulley 62 is turned, which turns the rear wheel 30 via the drive sprocket 66 and the secondary chain 68.

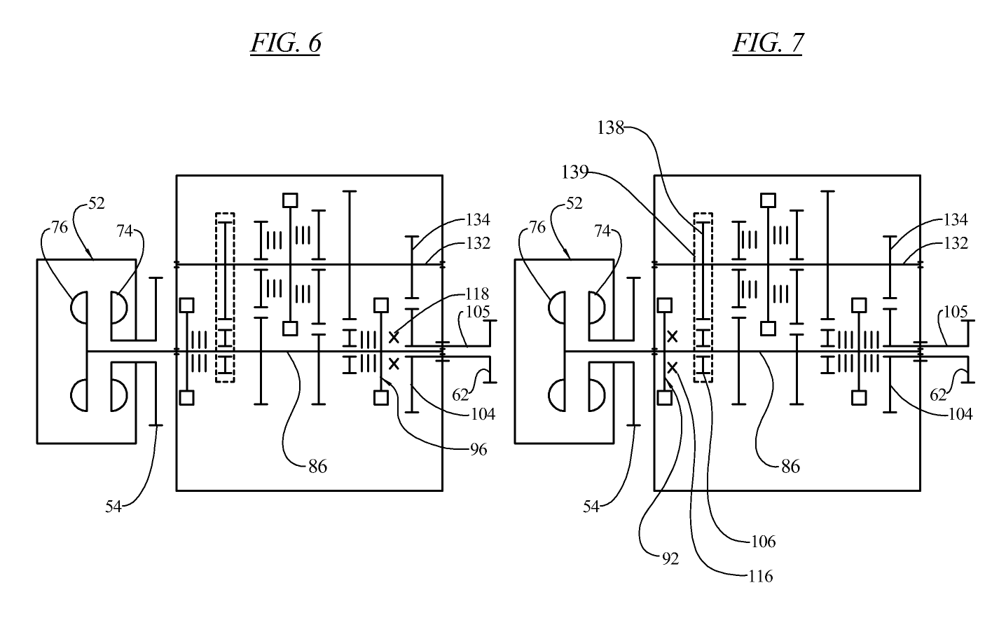

FIG. 6 illustrates the operation of the transmission in fourth gear mode. The torque converter 52 is turned via the input pulley 54. A fluid coupling within the torque converter turns the main shaft 86. The main shaft 86 turns the clutch plate 96. The control actuates clutch discs 118 to cause the clutch plate 96 to turn the fourth main drive gear 104 at the same speed as the clutch plate 96. The fourth gear 104 is fixed to the output pulley 62. The output pulley 62 is turned, which turns the rear wheel 30 via the drive sprocket 66 and the secondary chain 68.

FIG. 7 illustrates the operation of the transmission in reverse gear mode. The torque converter 52 is turned via the input pulley 54. A fluid coupling within the torque converter turns the main shaft 86. The main shaft 86 turns the clutch plate 92. The control actuates clutch discs 116 to cause the clutch plate 92 to turn the reverse main drive gear 106 at the same speed as the clutch plate 92. The reverse main drive gear 106 drives the reverse counter gear 138 in the same direction via the chain 139. The reverse counter gear 138 turns the counter shaft 132 which turns the counter drive gear 134. The counter drive gear 134 turns the fourth main drive gear 104 in an opposite direction. The fourth main drive gear 104 is fixed to the output pulley 62 via the output shaft 105. The output pulley 62 is turned, which turns the rear wheel 30 via the drive sprocket 66 and the secondary chain 68.

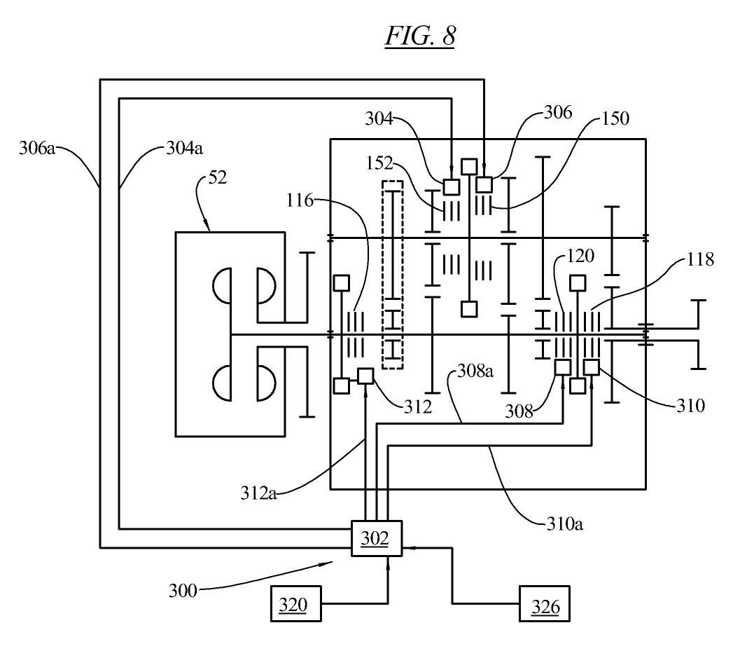

FIG. 8 illustrates a control system 300 of the invention. A controller 302 is in signal-communication with clutch engagement devices 304, 306, 308, 310, 312 through signal conductors 304a, 306a, 308a, 310a, 312a respectively. The controller 302 receives input signals via sensors 320. The input signals can be parameters such as engine RPM, transmission RPM, throttle position, engine torque, gear lever position for gear selection, or other parameters. A manual control override 326 can be used to manually select the gear mode of operation.

The clutch engagement devices 304, 306, 308, 310, 312 can be electromechanical devices, hydraulic or fluid operate devices such as disclosed in U.S. Pat. Nos. 2,825,235; or 4,627,312, herein incorporated by reference. Preferably, the clutch engagement devices are analog or digital solenoids that control hydraulic actuators. Solenoids can also control torque converter fluid fill and fluid line pressure. The controller correlates the input from the sensors 320 to select the appropriate gear mode of operation, such as a first gear mode, second gear mode, third gear mode, fourth gear mode or reverse gear mode. The corresponding engagement device 304, 306 308, 310, 312 is energized to engage the selected one of the friction disks 116, 118, 120, 150, 152, while the respective other friction disks remain disengaged; or no engagement device is engaged so the transmission remains in neutral mode.

The controller 302 can be an electronic controller and the system can be an electronic system, such as disclosed in U.S. Pat. Nos. 6,604,438 or 4,627,312, herein incorporated by reference. Alternatively, the controller 302 could be a fluid or pneumatically operated valve selector. Preferably, the controller 302 is a programmable electronic controller (PLC) that sends a signal to one or more electromagnetic valves, or solenoid valves, to control actuation of the clutches. Depending on the type of system and controller 302 and the type of engagement devices 304, 306, 308, 310, 312 the conductors 304a, 306a, 308a, 310a, 312a can be electric wires, optical fibers, fluid lines, or other known signal carrying conduit.

FIGS. 1-8 are diagrammatic or schematic drawings and the description herein leaves out information that would be within the knowledge and skill of one of skill in the art. For example, the gears and shafts within the transmission casing would require the necessary bearings and oil seals for proper design and operation. The placement and design of such elements are within the skill of one of ordinary skill in the art.

From the foregoing, it will be observed that numerous variations and modifications may be effected without departing from the spirit and scope of the invention. It is to be understood that no limitation with respect to the specific apparatus illustrated herein is intended or should be inferred.

What is claimed is:

1. A transmission for a vehicle, comprising:
an output shaft;
a main shaft arranged to receive rotary power and a countershaft arranged in parallel to said main shaft, said main shaft carrying a plurality of main gears, said countershaft carrying a plurality of counter gears, and a plurality of gear pairs formed by each of said main gears and one of said counter gears, said gear pairs in constant mesh, and a plurality of clutch devices arranged to select a gear pair from said plurality of gear pairs that will transmit torque to said output shaft; and
a main reverse gear on the main shaft, a counter reverse gear on the counter shaft and a chain wrapping the main reverse gear and the counter reverse gear, the chain causing the main and counter reverse gears to rotate in a common direction, a reverse clutch device arranged to selectively fix one of the main and counter reverse gears to its respective main or counter shaft for rotation therewith.

2. The transmission according to claim 1, wherein at least one clutch device comprises a clutch plate fixed on said main shaft, and at least one clutch friction disk arranged between said clutch plate and one gear of said select gear pair, said friction disk engageable to said clutch plate and to said one gear to transmit torque between said clutch plate and said one gear.

3. The transmission according to claim 1, wherein at least one clutch device comprises a clutch plate fixed on said countershaft, and at least one clutch friction disk arranged between said clutch plate and one gear of said select gear pair, said friction disk engageable to said clutch plate and to said one gear to transmit torque between said clutch plate and said one gear.

4. The transmission according to claim 1, wherein said main shaft receives power at one end and a fourth gear is furthest from said one end.

5. The transmission according to claim 4, wherein a first gear is located between said fourth gear and said one end.

6. The transmission according to claim 5, wherein a second gear is located between said first gear and said one end.

7. The transmission according to claim 6, wherein a third gear is located between said second gear and said one end.

8. The transmission according to claim 7, wherein the main reverse gear is located on the main shaft between the one end and the third gear.

9. The transmission according to claim 1, wherein during reverse gear mode, the main reverse gear drives the counter reverse gear which drives the counter shaft which drives a counter drive gear which drives a main drive gear rotatable on the main shaft which drives the output shaft.

10. An automatic transmission for a vehicle having a rotary power source, comprising:
an output shaft;
a torque converter having a torque converter housing, a torque converter input arranged to receive rotary power from the rotary power source and a torque converter output for transmitting rotary power, and fluid coupling elements arranged within said housing to transmit torque between the torque converter input and said torque converter output;
a geartrain having a main shaft for receiving rotary power from said torque converter output and a countershaft arranged in parallel to said main shaft, said main shaft carrying a plurality of main gears, said countershaft carrying a plurality of counter gears, and a plurality of gear pairs formed by each of said main gears being arranged to form one gear pair with one of said counter gears, said gear pairs in constant mesh, and at least one clutch plate fixed to one of said main shaft and said counter shaft and having engageable opposite sides, said clutch plate arranged between alternately selectable gear pairs, and at least one friction disk arranged between each of said selectable gear pairs and one engageable opposite side of said clutch plate, said friction disk selectively actuatable to engage one gear of said selectable gear pair and said clutch plate to transmit torque between said clutch plate and said selectable gear pair to transmit torque to said output shaft; and
a main reverse gear on the main shaft, a counter reverse gear on the counter shaft and a chain wrapping the main reverse gear and the counter reverse gear, the chain causing the main and counter reverse gears to rotate in a common direction, a reverse clutch device arranged to selectively fix one of the main and counter reverse gears to its respective main or counter shaft for rotation therewith.

11. The transmission according to claim 10, wherein at least one clutch device comprises a clutch plate fixed on said main shaft, and at least one clutch friction disk arranged between said clutch plate and one gear of said select gear pair, said friction disk engageable to said clutch plate and to said one gear to transmit torque between said clutch plate and said one gear.

12. The transmission according to claim 11, wherein at least one clutch device comprises a clutch plate fixed on said countershaft, and at least one clutch friction disk arranged between said clutch plate and one gear of said select gear pair, said friction disk engageable to said clutch plate and to said one gear to transmit torque between said clutch plate and said one gear.

13. The transmission according to claim 10, wherein said main shaft receives power at one end and a fourth gear is furthest from said one end.

14. The transmission according to claim 13, wherein a first gear is located between said fourth gear and said one end.

15. The transmission according to claim 14, wherein a second gear is located between said first gear and said one end.

16. The transmission according to claim 15, wherein a third gear is located between said second gear and said one end.

17. The transmission according to claim 16, wherein the main reverse gear is located on the main shaft between the one end and the third gear.

18. The transmission according to claim 10, wherein during reverse gear mode, the main reverse gear drives the counter reverse gear which drives the counter shaft which drives a counter drive gear which drives a main drive gear rotatable on the main shaft which drives the output shaft.

19. The transmission according to claim 10, wherein the main shaft receives rotary power from the torque converter output at one end of the main shaft, and the output shaft is rotatable coaxially on the main shaft on an end of the main shaft opposite to the one end.
